(19) United States
(12) Patent Application Publication
(10) Pub. No.: US 2023/0382262 A1
(43) Pub. Date: Nov. 30, 2023

(54) SERVER AND CONTROL METHOD THEREOF

(71) Applicants: Hyundai Motor Company, Seoul (KR); Kia Corporation, Seoul (KR)

(72) Inventors: Seungwoo HA, Seoul (KR); Yunsun KIM, Seoul (KR); Haemin SONG, Seoul (KR); Yejin SONG, Yongin-si (KR)

(73) Assignees: Hyundai Motor Company, Seoul (KR); Kia Corporation, Seoul (KR)

(21) Appl. No.: 18/078,361

(22) Filed: Dec. 9, 2022

(30) Foreign Application Priority Data
May 27, 2022 (KR) 10-2022-0065113

(51) Int. Cl. B60L 53/68; B60L 58/12; B60L 55/00; B60L 53/30; B60L 53/18; B60L 53/66; G06Q 30/0201

(52) U.S. Cl. CPC B60L 53/68; B60L 58/12; B60L 55/00; B60L 53/305; B60L 53/18; B60L 53/665; G06Q 30/0206

(57) ABSTRACT

A server according to an embodiment includes a communicator communicating with a vehicle and a charger and a controller determining a required state of charge (SoC) of the vehicle based on state information of the vehicle, controlling a charger to maximize an expected profit via charging and discharging a battery of the vehicle while pursuing the required SoC based on time-dependent electricity rate information. The controller controls, upon a discharge priority condition being satisfied, the charger to maximize the expected profit by updating the time-dependent electricity rate information.

### CROSS-REFERENCE TO RELATED APPLICATION(S)

This application claims the benefit of priority to Korean Patent Application No. 10-2022-0065113, filed on May 27, 2022 in the Korean Intellectual Property Office, the disclosure of which is incorporated herein by reference.

### TECHNICAL FIELD

The present disclosure relates to a server for vehicle to grid (V2G) operation and a control method thereof.

### BACKGROUND

A V2G system refers to a technology that uses electric vehicles (EVs) as energy storage devices by connecting the EVs to buildings. That is, the V2G system allows the State of charge (SoC) of the battery of an electric vehicle to remain at a target SoC and to discharge, upon the SoC of the battery of the electric vehicle being higher than the target SoC, the battery of the electric vehicle to charge the battery of a building for generating profits.

In the V2G system operating in this way, the battery of an electric vehicle can be charged and discharged repeatedly to generate profits, which brings the necessity of a method for operating the efficient V2G system efficiently using various information such as electricity bill, demand response, building power usage, and vehicle usage information to increase the operating profit of the V2G system.

### SUMMARY

It is an object of the present disclosure to provide a server and a control method thereof that is capable of maximizing expected profit in such a way as to determine a vehicle's required SoC based on vehicle state information and control a charger to perform charging and discharging based on time-dependent electricity rate information and update, upon a discharge priority condition being satisfied, the time-dependent electricity rate information.

A server according to an embodiment may include a communicator communicating with a vehicle and a charger and a controller determining a required state of charge (SoC) of the vehicle based on state information of the vehicle, controlling a charger to maximize an expected profit via charging and discharging a battery of the vehicle while pursuing the required SoC based on time-dependent electricity rate information, and calculating, upon a discharge priority condition being satisfied, the expected profit by increasing an electricity rate at a corresponding time.

The controller may determine the expected profit via charging and discharging at the charger based on an output of an optimization algorithm with the time-dependent electricity rate information, the required SoC of the vehicle, and the discharge priority condition.

The controller may determine a sum of income from discharge and expenditure from charge, while pursuing the required SoC, as the expected profit through charging and discharging.

The controller may determine that the discharge priority condition is satisfied based on a power usage predicted by a vehicle to grid (V2G) system exceeding a target power production amount.

The controller may determine that the discharge priority condition is satisfied based on a demand response signal being received via a communicator.

The controller may correct the required SoC based on external temperature information of the vehicle and weather information.

The state information of the vehicle may include usage time information and destination information of the vehicle input by a user to a user terminal and received via a communicator.

The controller may control, upon the electricity rate information being updated, a communicator to transmit a message indicative of change of a charging/discharging schedule.

The controller may control the communicator to transmit, in response to charging up to the required SoC being impossible by a start time of use of the vehicle due to a change of the charging/discharging schedule, a message inquiring whether to disconnect from the charger.

A control method of a server according to an embodiment may include determining a required state of charge (SoC) of a vehicle based on state information of the vehicle, controlling a charger to maximize an expected profit via charging and discharging a battery of the vehicle while pursuing the required SoC based on time-dependent electricity rate information, and calculating, upon a discharge priority condition being satisfied, the expected profit by increasing an electricity rate at a corresponding time.

Determining the expected profit may include determining the expected profit via charging and discharging at the charger based on a output of an optimization algorithm with the time-dependent electricity rate information, the required SoC of the vehicle, and the discharge priority condition.

Determining the expected profit may include determining a sum of income from discharge and expenditure from charge, while pursuing the required SoC, as the expected profit through charging and discharging.

The discharge priority condition may be satisfied upon a power usage predicted by a vehicle to grid (V2G) system exceeding a target power production amount.

The discharge priority condition may be satisfied upon a demand response signal being received via a communicator.

The control method of the server may further include correcting the required SoC based on external temperature information of the vehicle and weather information.

The state information of the vehicle may include usage time information and destination information of the vehicle input by a user to a user terminal and received via a communicator.

The control method of the server may further include controlling, upon the electricity rate information being updated, a communicator to transmit a message indicative of change of a charging/discharging schedule.

Controlling the communicator may include controlling the communicator to transmit, in response to charging up to the required SoC being impossible by a start time of use of the vehicle due to a change of the charging/discharging schedule, a message inquiring whether to disconnect from the charger.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating a vehicle to grid (V2G) system according to an embodiment;

FIG. 2 is a control block diagram of a server according to an embodiment;

FIG. 3 schematically illustrates a case in which a server controls a V2G system according to an embodiment;

FIG. 4 is a diagram illustrating that the server predicts power usage in a V2G system and reflects a discharge priority condition in electricity rate information according to an embodiment;

FIG. 5 is a diagram illustrating that a server receives a Demand Response (DR) signal and reflects a discharge priority condition in electricity rate information according to an embodiment;

FIG. 6 is a diagram for explaining that a server updates electricity rate information according to an embodiment;

FIG. 7 is a diagram illustrating that a server selects a path in which an expected profit is maximized by updated electricity rate information according to an embodiment;

FIG. 8 is a flowchart illustrating a case of determining an optimal charging/discharging schedule by determining and correcting a required SoC and determining an expected profit in a control method of a server according to an embodiment;

FIG. 9 is a flowchart illustrating a case in which a building energy usage exceeds a target power usage among discharge priority conditions in a control method of a server according to an embodiment; and

FIG. 10 is a flowchart illustrating a case of receiving a DR signal among discharge priority conditions in a control method of a server according to an embodiment.

### DETAILED DESCRIPTION

Throughout the specification, the same reference numerals refer to the same components. This specification does not describe all elements of the embodiments, and well-known descriptions in the art or repeated descriptions between the embodiments are omitted.

Throughout the specification, when a part is “connected” to another part, this includes a case of being directly connected as well as being connected indirectly, and indirect connection includes connecting through a wireless communication network.

Also, when a part is said to “comprise” a certain component, this means that other components may be further included instead of excluding other components unless specifically stated otherwise.

A singular expression includes a plural expression unless the context clearly has an exception.

In addition, terms such as “˜part”, “˜device”, “˜block”, “˜member”, and “˜module” may mean a unit for processing at least one function or operation. For example, the terms may mean at least one process processed by at least one hardware such as a field-programmable gate array (FPGA)/application specific integrated circuit (ASIC), at least one software stored in a memory, or a processor.

In each of steps, a reference numeral is used for convenience of description, and the reference numerals do not describe an order of the steps, the steps may be performed differently from the specified order, unless a specific order is explicitly stated in the context.

Hereinafter, an embodiment of a server 10 and a control method thereof according to an aspect will be described in detail with reference to the accompanying drawings.

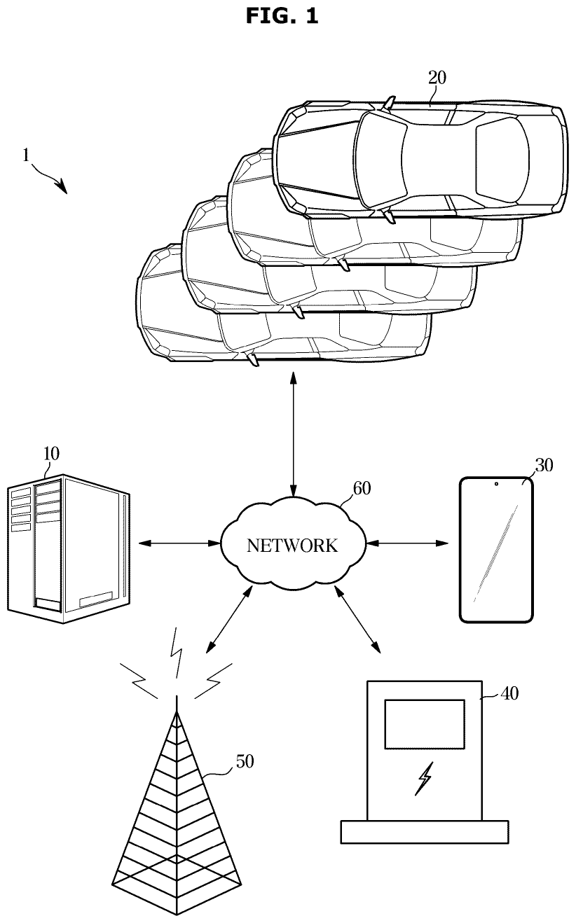

FIG. 1 is a diagram illustrating a vehicle to grid (V2G) system according to an embodiment.

With reference to FIG. 1, the V2G system 1 according to an embodiment may include a server 10 operating the V2G system 1, a plurality of vehicles 20 participating in the V2G system 1, a user terminal 40 of the driver of the vehicle 20, at least one charger 30 charging or discharging the battery of the vehicle 20, and a power grid 50 supplying power.

The V2G system 1 refers to a technology that connects an electric vehicle and a building to use the vehicle 20 as an energy storage device such that upon the electric power charged in the electric vehicle being sufficient, the electric vehicle can discharge the electric power for use in the building, generating profit.

To this end, the V2G system 1 includes a plurality of vehicles 20 and a plurality of chargers 30 capable of charging the vehicle 20 or delivering electric power discharged from the vehicle 20 to the building.

The server 10 according to an embodiment operates the V2G system 1 in such a way as to receive vehicle information including state of charge (SoC) information, reservation information, and location information from the vehicles 20 included in the V2G system 1 and schedule charging and discharging of each vehicle 20 based on the vehicle information.

For example, the server 10 may correspond to a management server 10 of a car rental company or a fleet company such as a vehicle sharing platform sharing the vehicles 20 and may schedule charging and discharging to optimize V2G operating profits based on time-dependent electricity rate information and necessary SoC information.

The vehicle 20 according to an embodiment may correspond to an electric vehicle including a motor and a battery for supplying power to the motor. However, the vehicle 20 may be a hybrid vehicle 20 further including an engine according to an embodiment.

The user terminal 40 according to an embodiment may be a terminal of a driver of the vehicle 20. For example, the user terminal 40 may be a terminal of a user using a service of a fleet company.

The user may reserve the use of the vehicle 20 through the user terminal 40, and the server 10 may receive reservation information of the vehicle 20 from the user terminal 40. However, the reservation information is not input only through the user terminal 40, but may be directly input via the terminal of the service provider of the server 10 depending on the embodiment.

Also, the user terminal 40 may receive a guide message for connection or disconnection of the charger 30 of the vehicle 20 from the server 10 and output the guide message to the user.

The charger 30 according to an embodiment may charge the battery of the vehicle 20 connected to the charger 30 or discharge the power charged in the battery of the vehicle 20 connected to the charger 30 to transmit power to the building participating in the V2G system 1, based on the charging/discharging command of the server 10.

The power grid 50 according to an embodiment may refer to a system in which an energy supply company supplying power supplies power to various consumers through a power distribution station.

Accordingly, the power grid 50 may supply power from the energy supplier to the vehicle 20 and the building and may transmit a demand response signal from the energy supplier to the server 10.

The power grid 50 according to an embodiment may include a smart grid. The smart grid combines information and communication technology with the existing power grid 50 so as to allow suppliers and consumers to exchange information in both directions and make the demand response, plus demand response (DR), and arbitrage happen.

Here, Demand Response means that electricity users change their electricity usage to meet the current demand for electricity and adjust their electricity usage based on a DR signal transmitted by the energy suppliers.

In addition, Plus DR refers to a demand management service in which consumers minimize output control by increasing electricity consumption when more electricity is produced than expected and, with V2G, residual energy can be used to charge EVs.

Arbitrage may refer to a method of generating profits by repeating charging/discharging using the difference in electricity rates by time.

Therefore, the power grid 50 according to an embodiment may send a DR signal to the server 10 and, upon receipt of the DR signal, the server 10 may update the time-dependent electricity rate information to control the charger 30.

Here, the server 10, the vehicle 20, the charger 30, the user terminal 40, and the power grid 50 may transmit and receive data to and from each other through the network 60.

The V2G system 1 has been briefly described above. Hereinafter, the server 10 of the V2G system 1 will be described in detail.

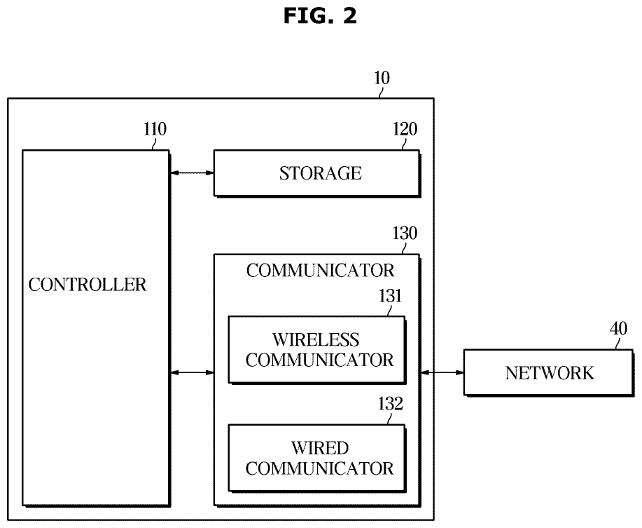

FIG. 2 is a control block diagram of a server 10 according to an embodiment.

With reference to FIG. 2, the server 10 according to an embodiment includes a communicator 130 for performing communication with an external device through the network 60, a controller 110 for operating the V2G system 1, and a storage 120 for storing various information necessary for control.

The communicator 130 according to an embodiment may transmit and receive data to and from the vehicle 20, the charger 30, the user terminal 40, and the power grid 50 through the network 60. To this end, the communicator 130 may be provided with at least one of a known type of wired communication module or a wireless communication module.

The communicator 130 may include one or more components that enable communication with an external device through the network 60, for example, at least one of a short-range communication module, a wired communicator 132 and a wireless communicator 131

The wireless communicator 130 may include a wireless communication interface including an antenna and a receiver for receiving a DR signal from the power grid 50. Also, the wireless communicator 130 may further include a signal conversion module for demodulating an analog-type wireless signal received through a wireless communication interface into a digital control signal.

The communicator 130 may receive current location and traffic situation information of the vehicle 20 from the vehicle 20 and usage time information of the vehicle 20 and destination information of the vehicle 20 from the user terminal 40.

The communicator 130 receives external temperature information and weather information from the vehicle 20 or the user terminal 40, and the server 10 may correct the required state of charge (SoC) using such information.

The communicator 130 may transmit to the vehicle 20 or the user terminal 40 a message indicative of a change of the charging/discharging schedule or a message inquiring whether to disconnect from the charger 30.

The storage 120 may include a volatile memory such as Static Random Access Memory (S-RAM) and Dynamic Random Access Memory (D-RAM) and a nonvolatile memory such as Read Only Memory (ROM) and Erasable Programmable Read Only Memory (EPROM).

The storage 120 may store various types of information for optimal charging/discharging scheduling in the V2G system 1, specifically, state information of the vehicle 20 such as use time information destination information of the vehicle 20.

The storage 120 may also store time-dependent electricity rate information in the form of a table and update the table to store the updated information according to the command of the controller 110.

The controller 110 according to an embodiment may determine the required SoC based on the state information of the vehicle 20, and control the charger 30 to maximize the profit expected by charging and discharging while pursuing the required SoC based on the time-dependent electricity rate information.

In detail, the controller 110 according to an embodiment may control the charger 30 to maximize the expected profit by updating the time-dependent electricity rate information upon a discharge priority condition being satisfied.

That is, the controller 110 may control the charger 30 to repeat charging or discharging the vehicle 20 based on the time-dependent electricity rate information to maximize the profit expected by charging and discharging the vehicle 20 to perform charging during a low electricity rate period and discharging during a high electricity rate period in the case where the electricity rate is high.

Here, the controller 110 may determine whether the discharge priority condition has occurred and perform, if it is determined that the discharge priority condition has occurred, discharging regardless of the electricity rate information.

Upon a discharge priority condition being satisfied, the controller 110 according to an embodiment may maximize the efficiency of the algorithm by changing the electricity rate table rather than setting an exception condition by modifying the optimal charging/discharging algorithm itself.

The controller 110 may determine the profit expected by the charging and discharging of the charger 30 based on the time-dependent electricity rate information, the required SoC of the vehicle 20, and the output of the optimization algorithm for the discharging priority condition.

Here, the controller 110 may determine the sum of the income generated by the discharging and the expenditure generated by the charging, while pursuing the required SoC, as the profit expected by the charging and discharging.

The controller 110 may predict the power usage in the V2G system 1 and determine that the discharge priority condition has occurred based on the predicted power usage exceeding the target power production.

Also, the controller 110 may determine that the discharge priority condition has occurred based on the receipt of a demand response signal from the communicator 130.

As such, the controller 110 may determine whether a discharge priority condition has occurred, and the discharge priority condition may mean a situation in which the vehicle 20 needs to perform discharge regardless of the time-dependent electricity rate according to time.

Therefore, the discharge priority condition is not limited to the above embodiment and may include all situations in which the vehicle 20 needs to discharge regardless of the time-dependent electricity rate, such as limiting the maximum power usage according to the electricity rate load criteria of the building.

The controller 110 may correct the required state of charge (SoC) determined based on external temperature information and weather information of the vehicle 20.

In detail, the required state of charge (SoC) may mean a battery charge rate of the vehicle 20 required for the vehicle 20 to travel to a destination in consideration of the current location of the vehicle 20 and traffic conditions.

The reason why the controller 110 corrects the required SoC of the vehicle 20 is that the drivable distance may vary depending on the temperature due to the physical characteristics of the battery and that additional energy is required for operating the air conditioner at a low or high temperature.

Accordingly, the controller 110 may correct the determined required state of charge (SoC) based on the external temperature information and the weather information, and the external temperature information and the weather information may be received from the vehicle 20 or the user terminal 40.

The controller 110 may control the communicator 130 to transmit a message indicative of a change of the charging/discharging schedule upon the electric charge information being updated due to the occurrence of the discharge priority condition.

In addition, if the charging/discharging schedule is changed so as to render charging up to the required SoC impossible by the start time of use of the vehicle 20, the controller 110 transmits a message inquiring whether to disconnect from the charger 30.

The controller 110 may update the electricity rate by reflecting the discharge priority condition and determine whether the required SoC can be reached during the charging time with the increased electricity rate.

Here, if the required SoC cannot be reached during the charging time due to the increased electricity rate, the controller 110 may transmit a message inquiring whether to disconnect from the charger 30 in order for the user of the vehicle 20 to connect the vehicle 20 to another charger 30 to reach the required SoC.

In this way, the controller 110 may give the user of the V2G system 1 a choice regarding charging of the vehicle 20 such that the user who prioritizes charging up to the required SoC connects the vehicle 20 to another charger 30 and the user who wants to continue charging, even if the required SoC is not reached, continues charging/discharging.

As such, the controller 110 may control the communicator 130 to perform optimal charging/discharging scheduling through dynamic programming and notify the user of the result.

The controller 110 may include at least one memory in which a program for performing the above-described operations and the operations to be described later is stored and at least one processor for executing the stored program. In the case where there are a plurality of memories and processors, they may be integrated on a single chip or may be provided in physically separate positions.

In the above, the description has been made of the configuration of each component of the server 10 in detail. Hereinafter, a description is made of the server 10 in detail with respect to updating the electricity rate information so as to maximize the operating profit of the V2G system 1.

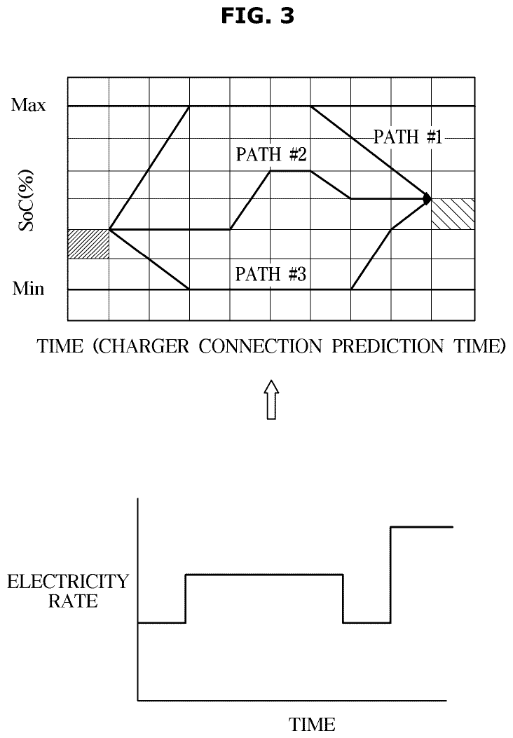

FIG. 3 schematically illustrates a case in which the server 10 controls the V2G system 1 according to an embodiment.

With reference to FIG. 3, the server 10 may select a path maximizing an expected profit among various paths based on time-dependent electricity rates.

The server 10 may determine the expected profit through the charging and discharging in the charger 30 based on the output of the optimization algorithm (e.g., dynamic programming (DP)) for the time-dependent electricity rate information, the required SoC, and the discharge priority signal.

Here, the server 10 may determine the sum of income according to discharging and expenditure according to charging as the expected profit while going from the current SoC to the required SoC based on the time-dependent electricity rate information and may select a charging/discharging schedule maximizing the expected profit.

For example, the server 10 may determine the optimized expected profit by using the objective equation that maximizes the sum of the amount of money generated during charging/discharging as shown in Equation 1 and the constraint including the required SoC.

max(Σᵢ₌₁^{N}Powerᵢ*Costᵢ) Equation 1

For example, as shown in FIG. 3, the server 10 may control charging and discharging along the path with the highest expected profit, which is the sum of income from discharge and expenditure from charge, among multiple paths (#1, #2, and #3) from the current SoC to the required SoC.

That is, the server 10 may perform charging/discharging with the path capable of increasing the operating profit of the V2G system 1 by lowering the expenditure of charging and increasing the income obtained through discharging in such a way as to charge the battery of the vehicle 20 in the section having a low electricity rate and discharge the battery of the vehicle 20 in the section having a high electricity rate.

As such, the server 10 can control the charger 30 to maximize the expected profit based on the state information of the vehicle 20 participating in the V2G system 1 and the time-dependent electricity rate information, resulting in optimization of the V2G system.

However, there may be a situation where a change in the external environment causes the vehicle 20 to discharge regardless of the electricity rate while the charger 30 is controlled to maximize the expected profit based on the electricity rate information, and a description of the control for such a situation is made hereinafter.

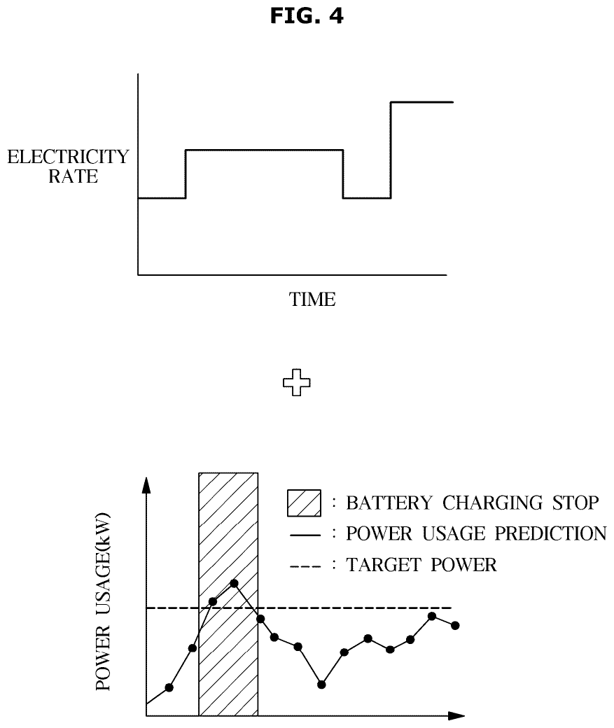

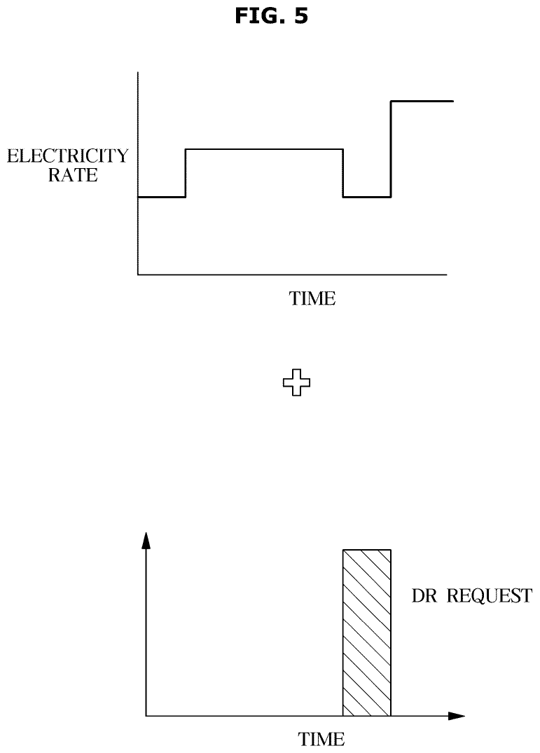

FIG. 4 is a diagram illustrating that the server 10 according to an embodiment predicts the power usage in the V2G system 1 and reflects the discharge priority condition in the electricity rate information, and FIG. 5 is a diagram illustrating that the server 10 according to an embodiment receives a Demand Response (DR) signal and reflects the discharge priority condition in electricity rate information.

Upon the discharge priority condition being satisfied, the controller 110 may update the electricity rate information according to the time by increasing the electricity rate corresponding to the time when the discharge priority condition is satisfied.

Here, the discharge priority condition may mean a case where the vehicle 20 needs to discharge regardless of the electricity rate according to a change in the external environment.

In detail, the discharge priority condition may include a case where it is determined that the estimated building power usage in the V2G system 1 exceeds the target power production or a case where a DR signal is received from an energy supplier through the power grid 50.

With reference to FIG. 4, upon determining that the predicted building power usage in the V2G system 1 exceeds the target power production due to a change in the external environment, the controller 110 may stop charging the vehicle 20 in the corresponding section because the power for use in the building may become insufficient.

Afterward, the controller 110 may control the charger 30 to discharge from the vehicle 20 to the building in order to prevent the power for use in the building from becoming insufficient.

Here, the server 10 according to an embodiment may generate an arbitrary electricity rate table to control the charger 30 to discharge from the vehicle 20 to the building regardless of the electricity rate.

With reference to FIG. 5, upon receipt of a demand response (DR) signal, the controller 110 may stop charging of the vehicle 20 in the corresponding section as in FIG. 4.

DR means that electricity users change their electricity usage to meet the current demand for electricity and adjust their electricity usage based on a DR signal transmitted by the energy suppliers.

As in FIG. 4, the controller 110 may control the charger 30 to discharge from the vehicle 20 to the building in order to prevent the power for use in the building from becoming insufficient.

In the server 10 according to an exemplary embodiment, the controller 110 may update the electricity rate information without changing the optimal scheduling algorithm maximizing the expected profit and reflect the discharge priority condition in the algorithm.

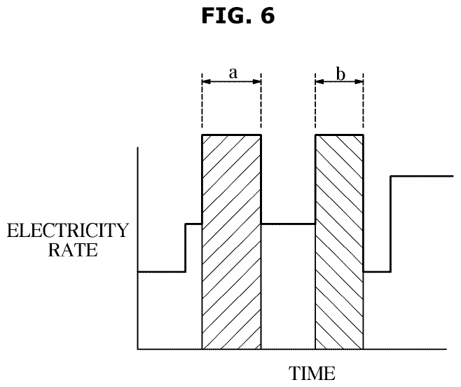

FIG. 6 is a diagram for explaining that the server 10 updates the electricity rate information according to an embodiment.

As described with reference to FIGS. 4 and 5, the controller 110 may update the electricity rate information without changing the optimal scheduling algorithm maximizing the expected profit and reflect the discharge priority condition in the algorithm.

That is, if the controller 110 has to modify the optimal scheduling algorithm itself to reflect the discharge priority condition, the algorithm becomes complicated, resulting in reduction of the operating efficiency of the V2G system 1.

The server 10 according to an embodiment may update the electricity rate information used in the optimal scheduling algorithm without change in operation of an optimal scheduling algorithm that maximizes the expected profit through charging and discharging.

Therefore, the server 10 according to an embodiment is capable of improving the system operating efficiency using the optimal scheduling algorithm without any exceptional condition, by simply updating the electricity rate table stored in the storage 120 in real time rather than changing the optimal scheduling algorithm.

With reference to FIG. 6, the controller 110 may change the electricity rate information stored in the storage 120.

The controller 110 may increase the electricity rate in section (a) upon determining that the predicted building power usage in the V2G system 1 exceeds the target power production.

In addition, the controller 110 may increase the electricity rate in section (b) upon receipt of the demand response (DR) signal.

As such, in the case where the discharge priority condition is satisfied, the actual electricity rate is not changed, but the controller 110 may control the discharge to be performed at a high electricity rate by arbitrarily increasing the electricity rate for efficient system operation.

As a result, the server 10 according to an embodiment may generate an arbitrarily high electricity rate table to prevent charging at a time when discharging is required such as when the V2G system 1 predicts building power usage exceeds the target power production or a demand response (DR) signal is received.

Accordingly, the controller 110 performs discharging at a high electricity rate in response to discharge being essential, making it possible to achieve the advantage of operating the V2G system 1 efficiently by reflecting the exceptional circumstances while maximizing the expected profit through charging and discharging in the V2G system 1.

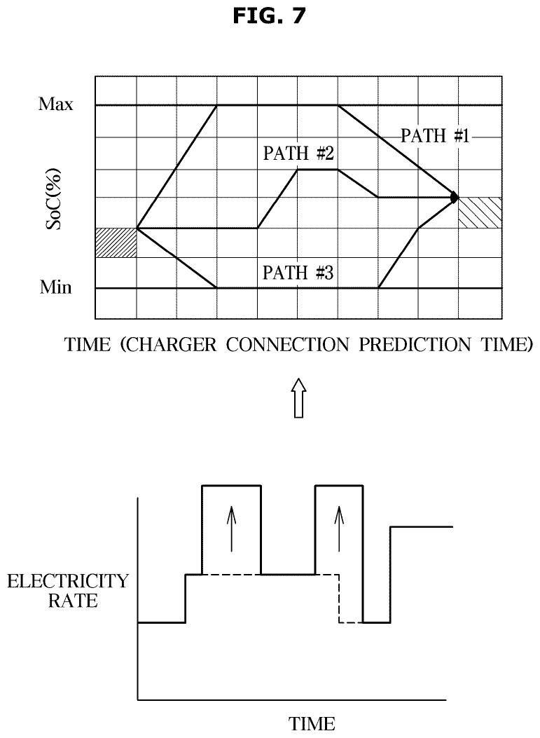

FIG. 7 is a diagram illustrating that the server 10 according to an embodiment selects a route in which an expected profit is maximized by updated electricity rate information.

As shown in FIG. 6, the controller 110 may arbitrarily increase the electricity rate during a time period in which discharge is required and may reset a path to reach the required SoC in consideration of this.

In this process, the controller 110 may use dynamic programming, which divides a large problem into small problems to find an optimal solution, stores solutions to the small problems, and uses the prestored solutions to the small problems to solve the larger problem.

There is no limit to the method of obtaining an optimal solution using dynamic programming in the server 10 according to an embodiment, and a shortest path algorithm can be applied to select a path with the highest expected profit by multiplying the weight by negative numbers and transforming it into the longest path algorithm.

However, the method for obtaining the optimal solution is not limited to the above, and various algorithms may be applied.

With reference to FIG. 7, in the portion of the dotted line indicating the existing electricity rate, the electricity rate is not higher than the maximum electricity rate, and thus charging may be performed.

However, in the portion of the solid line indicating the electricity rate reflecting the discharge priority condition, the controller 110 may perform discharging at the corresponding time when the electricity rate is higher than the maximum electricity rate.

Accordingly, the controller 110 may control the charger 30 to select a path #3 for discharging instead of the path #1 and path #2 for charging at the increased electricity rate.

As a result, the controller 110 may change the path by reflecting the discharging priority condition in real time while calculating the path corresponding to the maximum benefit among various charging paths satisfying the constraint conditions.

Since the vehicle 20 reaches the required SoC during the same time no matter which path is selected among path #1, path #2, and path #3, the user can operate the vehicle 20 with the desired SoC when using the vehicle 20.

However, with the server 10 according to an embodiment, the user can create the maximum profit in the charging process even if the vehicle 20 is charged to the desired SoC during the same time even in consideration of the power usage of the building, resulting in maximization of the efficiency of the V2G system.

Hereinafter, an embodiment of a control method of the server 10 according to an aspect will be described. The server 10 according to the above-described embodiment may be used in the control method of the server 10. Accordingly, the above description made with reference to FIGS. 1 to 7 may be equally applied to a control method of the server 10.

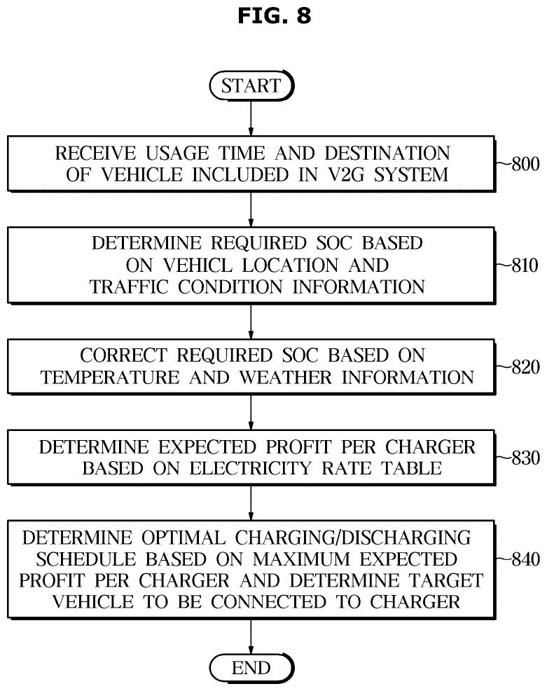

FIG. 8 is a flowchart illustrating a case of determining an optimal charging/discharging schedule by determining and correcting a required SoC in the control method of the server 10 according to an embodiment.

The server 10 according to an embodiment may receive, at step 800, the usage time and destination of the vehicle 20 included in the V2G system 1.

The usage time and destination of the vehicle 20 included in the state information of the vehicle 20 may be information input by the user into the user terminal 40 or input into the vehicle 20.

The controller 110 may control the communicator 130 to receive the usage time and destination of the vehicle 20 and use the information to determine an expected profit per charger 30.

That is, the controller 110 may determine a path to reach the required SoC differently because the required capacity of the battery varies according to the usage time of the vehicle 20 and the distance to the destination.

Afterward, the controller 110 may determine, at step 810, the required SoC based on the current location of the vehicle 20 and traffic condition information.

That is, the controller 110 may determine the required SoC by predicting the SoC with consumption according to the current location of the vehicle 20 and traffic condition information.

The controller 110 may determine the SoC at the time when the charger 30 starts charging as the current SoC and may differently determine the required SoC based on the current SoC in consideration of the current location and traffic conditions of the vehicle 20.

That is, in the case where the distance between the current location and the destination of the vehicle 20 is long or the vehicle 20 passes through a congested section, the controller 110 determines a higher required SoC than when the distance to the destination is close or when passing through a smooth section.

Afterward, the controller 110 may correct the required SoC based on the temperature information and the weather information at step 820.

The reason why the controller 110 corrects the required SoC of the vehicle 20 is that the drivable distance may vary depending on the temperature due to the physical characteristics of the battery and that additional energy is required for operating the air conditioner at a low or high temperature.

After correcting the required SoC, the controller 110 may determine an expected profit per charger 30 based on the electricity rate table at step 830.

Since the V2G system 1 may include a plurality of vehicles 20 and a plurality of chargers 30, it is possible to determine the expected profit for the plurality of chargers 30, and the user may select the charger 30 with the maximum expected profit.

The controller 110 may determine, at step 840, an optimal charging/discharging schedule based on the maximum expected profit per charger 30 and determine the target vehicle 20 to be connected to the charger 30.

That is, the controller 110 may select a path corresponding to the highest expected profit determined by summing the expenditure from charge and the income from discharge is the largest while charging and discharging from the current SoC to the required SoC.

Accordingly, the user can use the V2G system 1 with maximum profit, and the V2G system 1 can efficiently operate the system without wasting power as much as possible.

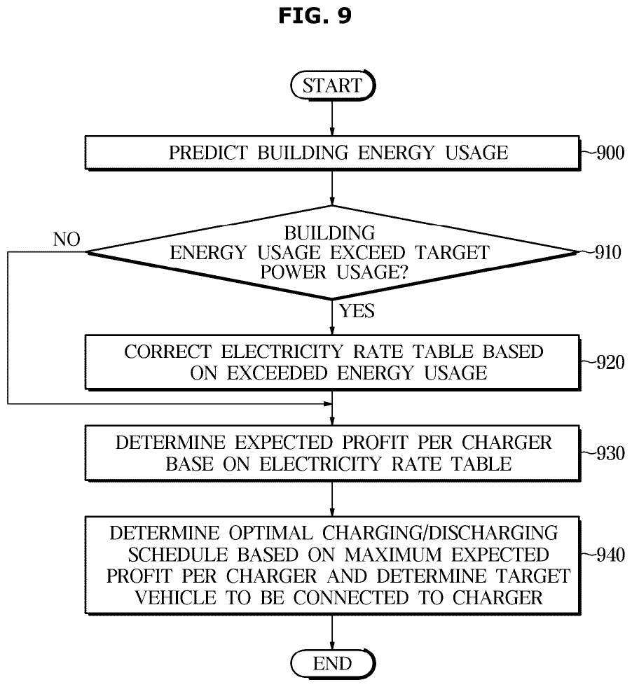

FIG. 9 is a flowchart illustrating a case in which a building energy usage exceeds a target power usage among discharge priority conditions in the control method of the server 10 according to an embodiment.

With reference to FIG. 9, the controller 110 according to an embodiment may predict, at step 900, the energy usage of the building included in the V2G system 1.

The controller 110 may monitor the energy usage of the building in real time as well as predicting the energy usage of the building.

Afterward, the controller 110 may determine at step 910 whether the energy usage of the current building exceeds the target power usage. Here, the controller 110 may predict whether the energy usage of the building exceeds the target power usage at a future time point.

Upon determining that there is a time period in which the energy usage of the building exceeds the target power usage (Yes at step 910), the controller 110 may correct, at step 920, the electricity rate table based on the exceeded energy usage.

In detail, upon determining that the predicted building power usage in the V2G system 1 exceeds the target power production due to a change in the external environment, the controller 110 may update the electricity rate table to stop charging of the vehicle 20 in the corresponding section because the power for use in the building may become insufficient.

Afterward, the controller 110 may determine, at step 930, an expected profit per charger 30 based on the updated electricity rate table.

Upon determining that there is no time period in which the energy usage of the building exceeds the target power usage (No at step 910), the controller 110 may determine the expected profit with the same algorithm used in the case of determining that there is a time period in which the energy usage of the building exceeds the target power usage (Yes at step 910).

That is, although determining the expected profit with the same algorithm, the controller 110 updates, upon a discharge priority condition for supplying energy to the building being satisfied, the electric charge table to discharge the electricity efficiently.

Afterward, the controller 110 may determine, at step 940, an optimal charging/discharging schedule based on a charging/discharging path corresponding to the maximum expected profit per charger 30 and may determine the target vehicle 20 to be connected to the charger 30.

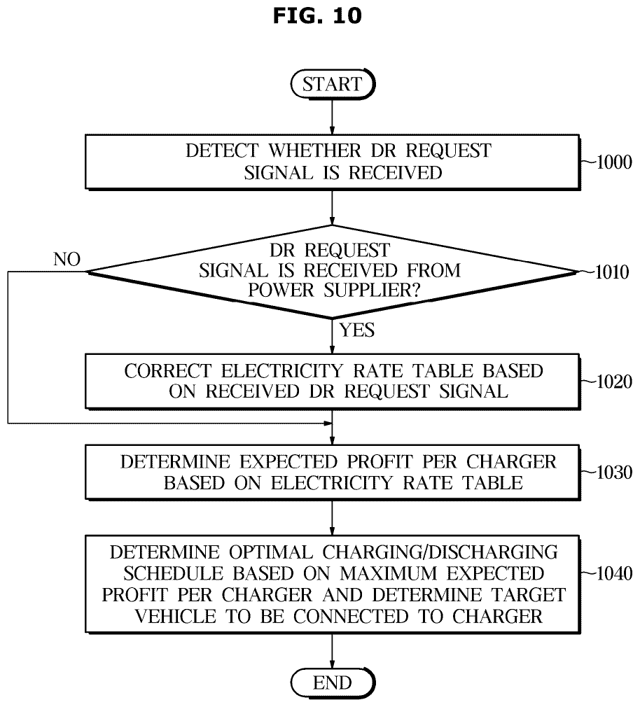

FIG. 10 is a flowchart illustrating a case of receiving a DR signal among discharge priority conditions in the control method of the server 10 according to an embodiment.

With reference to FIG. 10, as in FIG. 9, the controller 110 according to an embodiment may in real time detect, at step 1000, whether a DR signal, which is a demand response request signal, is received.

Afterward, the controller 110 may determine at step 1010 whether the DR request signal is received from an energy supply company as a power supplier. Here, the controller 110 may predict whether to receive the DR signal from the energy supply company at a future time point.

Upon determining that the DR request signal is received from the power supplier (YES at step 1010), the controller 110 may correct the electricity rate table based on the received DR signal at step 1020.

In detail, upon determining that the DR signal is received, the controller 110 may update the electricity rate table to stop charging the vehicle 20 in the corresponding section because the power for use in the building may be insufficient.

Afterward, the controller 110 may determine, at step 1030, an expected profit per charger 30 based on the updated electricity rate table.

Here, the controller 110 may determine the expected profit with the same algorithm in both the cases of receipt of the DR signal (YES at step 1010) and failure of receipt of the DR signal (NO at step 1010).

Afterward, the controller 110 may determine, at step 1040, an optimal charging/discharging schedule based on a charging/discharging path corresponding to the maximum expected profit per charger 30 and may determine the target vehicle 20 to be connected to the charger 30.

Accordingly, the controller 10 performs discharging at a high electricity rate in response to discharge being essential, making it possible to operate the V2G system 1 efficiently by reflecting the exceptional circumstances while maximizing the expected profit through charging and discharging in the V2G system 1.

According to one aspect of the present disclosure, the server and control method thereof are capable of increasing system operation efficiency using an optimization algorithm without exception conditions by reflecting external environmental information in the electricity rate table and capable of operating V2G efficiently by increasing the reliability of the SoC required for use of a vehicle.

Meanwhile, the disclosed embodiments may be implemented in the form of a recording medium storing instructions executable by a computer. The instruction may be stored in the form of a program code, and when executed by a processor, a program module may be generated to perform operations of the disclosed embodiments. The recording medium may be implemented as a non-transitory computer-readable recording medium.

The non-transitory computer-readable recording medium includes any type of recording medium in which instructions readable by the computer are stored. For example, there may be a read only memory (ROM), a random access memory (RAM), a magnetic tape, a magnetic disk, a flash memory, an optical data storage device, and the like.

However, since the non-transitory computer-readable recording media may include any type of recording media in which instructions readable by a computer are stored, there is no limitation on the media as long as the instructions can be stored therein.

The disclosed embodiments have been described as above with reference to the accompanying drawings. Those skilled in the art will understand that the present disclosure may be implemented in a form different from the disclosed embodiments without changing the technical spirit or essential features of the present disclosure. The disclosed embodiments are illustrative and should not be construed as limiting.

What is claimed is:

1. A server comprising:
a communicator communicating with a vehicle and a charger; and
a controller configured to determine a required state of charge (SoC) of the vehicle based on state information of the vehicle, control a charger to maximize an expected profit via charging and discharging a battery of the vehicle while pursuing the required SoC based on time-dependent electricity rate information, and calculate, upon a discharge priority condition being satisfied, the expected profit by increasing an electricity rate at a corresponding time.

2. The server of claim 1, wherein the controller is further configured to determine the expected profit via charging and discharging at the charger based on an output of an optimization algorithm with the time-dependent electricity rate information, the required SoC of the vehicle, and the discharge priority condition.

3. The server of claim 2, wherein the controller is further configured to determine a sum of income from discharge and expenditure from charge, while pursuing the required SoC, as the expected profit through charging and discharging.

4. The server of claim 1, wherein the controller is further configured to determine that the discharge priority condition is satisfied based on a power usage predicted by a vehicle to grid (V2G) system exceeding a target power production amount.

5. The server of claim 1, wherein the controller is further configured to determine that the discharge priority condition is satisfied based on a demand response signal being received via the communicator.

6. The server of claim 1, wherein the controller is further configured to correct the required SoC based on external temperature information of the vehicle and weather information.

7. The server of claim 1, wherein the state information of the vehicle comprises usage time information and destination information of the vehicle input by a user to a user terminal and received via the communicator.

8. The server of claim 1, wherein the controller is further configured to control, upon the electricity rate information being updated, the communicator to transmit a message indicative of change of a charging/discharging schedule.

9. The server of claim 8, wherein the controller is further configured to control the communicator to transmit, in response to charging up to the required SoC being impossible by a start time of use of the vehicle due to a change of the charging/discharging schedule, a message inquiring whether to disconnect from the charger.

10. A method of controlling a server, the method comprising:
determining a required state of charge (SoC) of a vehicle based on state information of the vehicle;
controlling a charger to maximize an expected profit via charging and discharging a battery of the vehicle while pursuing the required SoC based on time-dependent electricity rate information; and
calculating, upon a discharge priority condition being satisfied, the expected profit by increasing an electricity rate at a corresponding time.

11. The method of claim 10, wherein determining the expected profit comprises determining the expected profit via charging and discharging at the charger based on an output of an optimization algorithm with the time-dependent electricity rate information, the required SoC of the vehicle, and the discharge priority condition.

12. The method of claim 11, wherein determining the expected profit comprises determining a sum of income from discharge and expenditure from charge, while pursuing the required SoC, as the expected profit through charging and discharging.

13. The method of claim 10, wherein the discharge priority condition is satisfied upon a power usage predicted by a vehicle to grid (V2G) system exceeding a target power production amount.

14. The method of claim 10, wherein the discharge priority condition is satisfied upon a demand response signal being received via a communicator.

15. The method of claim 10, further comprising: correcting the required SoC based on external temperature information of the vehicle and weather information.

16. The method of claim 10, wherein the state information of the vehicle comprises usage time information and destination information of the vehicle input by a user to a user terminal and received via a communicator.

17. The method of claim 10, further comprising controlling, upon the electricity rate information being updated, a communicator to transmit a message indicative of change of a charging/discharging schedule.

18. The method of claim 17, wherein controlling the communicator comprises controlling the communicator to transmit, in response to charging up to the required SoC being impossible by a start time of use of the vehicle due to a change of the charging/discharging schedule, a message inquiring whether to disconnect from the charger.
